(19) United States
(12) Patent Application Publication
(10) Pub. No.: US 2026/0253910 A1
(43) Pub. Date: Aug. 27, 2026

(54) Ultrafine Vacancy-Rich Co9S8-x/MnS-Decorated S, N-Doped Hollow Carbon Nanotube Derived via Cooperative In-Situ Sulfidation and Interface Tuning as a Bifunctional Oxygen Electrocatalyst for High-Performance Zinc-Air Batteries

(71) Applicant: KOREA ADVANCED INSTITUTE OF SCIENCE AND TECHNOLOGY, Daejeon (KR)

(72) Inventors: Jeungku KANG, Daejeon (KR); Khumujam Debarani DEVI, Daejeon (KR); Dong Won KIM, Daejeon (KR)

(73) Assignee: KOREA ADVANCED INSTITUTE OF SCIENCE AND TECHNOLOGY, Daejeon (KR)

(21) Appl. No.: 19/550,761

(22) Filed: Feb. 26, 2026

(30) Foreign Application Priority Data
Feb. 26, 2025 (KR) 10-2025-0024814
May 29, 2025 (KR) 10-2025-0070164

(51) Int. Cl. H01M 4/86; H01M 4/88; H01M 4/90; H01M 4/96; H01M 12/08

(52) U.S. Cl. CPC H01M 4/8626; H01M 4/8615; H01M 4/8652; H01M 4/8882; H01M 4/9041; H01M 4/96; H01M 12/08

(57) ABSTRACT

Provided is Co9S8-x/MnS abundant with ultrafine vacancy decorated in a S, N-doped hollow carbon nanotube derived through in-situ sulfurization and interface adjustment, which is cooperative as a double function oxygen electrocatalyst for a high performance zinc-air battery, and it is characterized by including a hollow inside; and a metal sulfide-containing porous structure.

### CROSS-REFERENCE TO RELATED APPLICATIONS

This application claims the benefit of priority under 35 U.S.C. § 119 to Republic of Korea Patent Application No. 10-2025-0070164, filed May 29, 2025, and Republic of Korea Patent Application No. 10-2025-0024814, filed Feb. 26, 2025, the contents of which are incorporated herein by reference in their entirety.

### TECHNICAL FIELD

The following disclosure relates to a catalyst for a metal-air battery and a method for manufacturing the same.

### BACKGROUND

A zinc-air battery is receiving attention as a next-generation energy storage device, due to its advantages such as high energy density, relatively low material costs, and stability. The battery is operated by using oxygen in the air as a cathode reactant and using a zinc metal as an anode. The battery structure is characterized by theoretically providing much higher energy density than a traditional lithium ion battery.

However, a currently commercialized zinc-air battery has a limitation in that it does not sufficiently implement the theoretical performance during actual operation. This is because an oxygen reduction reaction (ORR) and an oxygen evolution reaction (OER) which occur mainly in an air-cathode have a very low reaction rate, and reversibility between the two reactions is low. Besides, an electrode structure is easily deteriorated in a repeating charge and discharge process to shorten lifespan.

Therefore, a study of a detergent composition which may remove a residue of an adhesive for fixing a wafer at a high cleaning rate without damaging a wafer protective layer or semiconductor components is urgently needed.

In order to solve the problem, a bifunctional catalyst based on a transition metal has been variously studied instead of a precious metal catalyst. For example, a sulfide catalyst using a metal such as cobalt (Co) or manganese (Mn), or a composite material in which they are dispersed in a carbon structure has been suggested. However, problems in which catalyst particles aggregate during a high-temperature process to decrease an active area, and in which absorption and desorption reactions of an oxygen intermediate are not balanced still remain unsolved.

Accordingly, research and development of a new electrode material which may increase catalyst activity and improve stability is required.

### SUMMARY

An embodiment of the present invention is directed to providing a bifunctional catalyst for a metal-air battery having excellent electrochemical performance and long-term stability in both an oxygen reduction reaction and an oxygen evolution reaction, and a method for manufacturing the same.

Another embodiment of the present invention is directed to providing an air-cathode which includes the catalyst and shows low overvoltage, and a metal-air battery including the same.

In order to achieve the above objects, the present inventors continued to study in order to manufacture a catalyst which may increase catalyst activity and improve stability, and as a result, found that when a catalyst in which a catalyst including a metal sulfide is dispersed in a doped carbon body having a porous structure is used, electron density at a metal center and adsorption energy of an oxygen intermediate are precisely adjusted to improve the reaction rate and reversibility of an oxygen electrochemical reaction simultaneously, thereby completing the present invention.

In one general aspect, a catalyst for a metal-air battery includes: a hollow inside; and a porous structure containing a metal sulfide.

According to an exemplary embodiment, the structure may include a carbon structure doped with two or more heteroatoms.

According to an exemplary embodiment, the structure may include a carbon structure doped with nitrogen (N) and sulfur (S).

According to an exemplary embodiment, the carbon structure of the structure may be a heterointerface in contact with two or more metal sulfides.

According to an exemplary embodiment, the carbon structure of the structure may include micropores and mesopores.

According to an exemplary embodiment, the structure may have a BET specific surface area of 200 m²/g or more.

According to an exemplary embodiment, the metal sulfide may be one or two or more metals selected from the group consisting of cobalt (Co), zinc (Zn), iron (Fe), cadmium (Cd), nickel (Ni), manganese (Mn), copper (Cu), and the like.

According to an exemplary embodiment, the metal sulfide may include a cobalt (Co) sulfide and a manganese (Mn) sulfide.

According to an exemplary embodiment, the metal sulfide may include particles having an average particle diameter of 1 to 15 nm.

According to an exemplary embodiment, the metal sulfide may have a structure in which some sulfur atoms in a crystal structure are vacant (S-vacancy).

According to an exemplary embodiment, the catalyst may have a surface contact angle of 100° or more.

According to an exemplary embodiment, the structure may have a thickness of 10 to 100 nm.

According to an exemplary embodiment, the catalyst may have a nanotube structure having an inner diameter of 10 to 300 nm and an outer diameter of 30 to 500 nm.

According to an exemplary embodiment, the catalyst may be a bifunctional catalyst.

In another general aspect, a catalyst precursor for a metal-air battery includes: a heteroelement-containing template including nitrogen (N) and sulfur (S); a metal-organic framework layer formed on a surface of the template; and a polymer coating layer on the metal-organic framework layer.

According to an exemplary embodiment, the template may have a nanorod structure.

According to an exemplary embodiment, the metal-organic framework layer may include an organic ligand, a first metal, a second metal, and a third metal.

According to an exemplary embodiment, the polymer coating layer may include a conductive polymer.

In another general aspect, an air-cathode includes a coating layer including the catalyst for a metal-air battery described above.

According to an exemplary embodiment, the coating layer may include 30 to 90 wt % of the catalyst for a metal-air battery.

In another general aspect, a metal-air battery includes: an anode; an electrolyte; and the air-cathode described above.

In still another general aspect, a method for manufacturing a catalyst for a metal-air battery includes:
(A) forming a heteroelement-containing template including nitrogen (N) and sulfur (S);
(B) forming a metal-organic framework layer on the template;
(C) forming a polymer coating layer on the metal-organic framework layer; and
(D) performing a heat treatment.

According to an exemplary embodiment, (A) may be self-assembling melamine and trithiocyanuric acid to manufacture a template.

According to an exemplary embodiment, (B) may include: forming a metal-organic framework including a first metal and a second metal; and introducing a third metal to the metal-organic framework.

According to an exemplary embodiment, (D) may be performed at a temperature of 700° C. or higher.

According to an exemplary embodiment, a part of the template may be vaporized to form a hollow structure, by performing (D).

According to an exemplary embodiment, a heteroelement may be doped into the polymer coating layer, and the metal of the metal-organic framework layer may be sulfurized to form a metal sulfide, by performing (D).

Other features and aspects will be apparent from the following detailed description, the drawings, and the claims.

### BRIEF DESCRIPTION OF THE DRAWINGS

FIG. 1 is a schematic diagram which simply shows a method for manufacturing a catalyst according to an exemplary embodiment.

In FIG. 2, (a) is an SEM image of a catalyst according to Example 1, (b) is a TEM image, (c) and (d) are HR-TEM images, and (e) is a schematic diagram showing a molecular structure of a catalyst according to Example 1.

FIG. 3 is a pore size distribution graph obtained by BET and BJH analyses of the catalyst according to Example 1.

FIG. 4 is a schematic diagram of a zinc air battery using the catalyst according to an exemplary embodiment as an air-cathode.

FIG. 5 is the results of a lighting experiment using a battery employing the catalyst according to Example 1.

FIG. 6 is a graph showing cycle life results of the battery of Example 1.

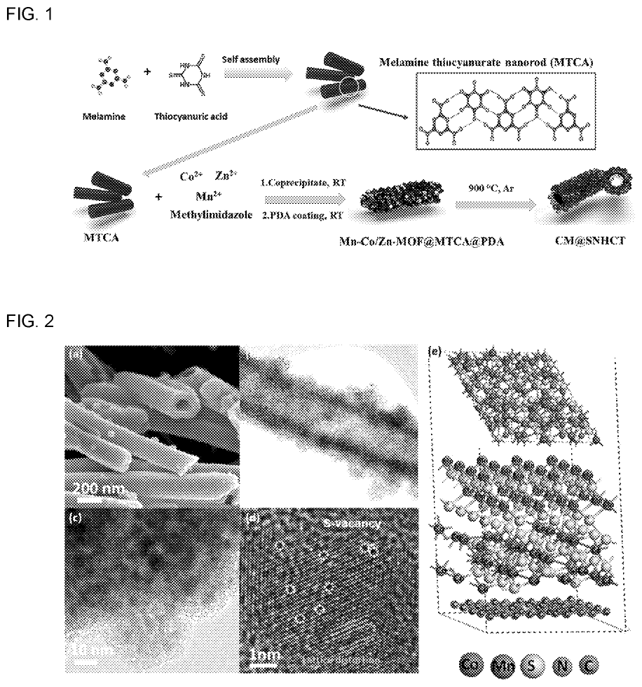

### DETAILED DESCRIPTION OF EMBODIMENTS

In the present specification, unless otherwise defined, all technical terms and scientific terms have the same meanings as those commonly understood by a person skilled in the art to which the present invention pertains. The terms used herein are only for effectively describing a certain specific example and are not intended to limit the present invention.

The singular form used in the present specification may also be intended to include a plural form, unless otherwise indicated in the context.

In addition, the numerical range used in the present specification includes all values within the range including the lower limit and the upper limit, increments logically derived in a form and span of a defined range, all double limited values, and all possible combinations of the upper limit and the lower limit in the numerical range defined in different forms. Unless otherwise defined in the present specification, values which may be outside a numerical range due to experimental error or rounding off of a value are also included in the defined numerical range.

The term “comprise” in the present specification is an open-ended description having a meaning equivalent to the term such as “is/are provided”, “contain”, “have”, or “is/are characterized”, and does not exclude elements, materials, or processes which are not further listed.

Hereinafter, the catalyst for a metal-air battery according to an exemplary embodiment of the present invention, and a method for manufacturing the same will be described in more detail.

The present invention provides a catalyst for a metal-air battery including: a hollow inside; and a porous structure containing a metal sulfide. The catalyst may have a structure including a hollow inside and a porous structure forming an outside in a nanotube form.

According to an exemplary embodiment, the structure may include a carbon structure doped with two or more heteroatoms, and the heteroatom may be any one or more selected from the group consisting of nitrogen, oxygen, silicon, sulfur, phosphorus, and the like. Specifically, the structure may include a carbon structure doped with nitrogen (N) and sulfur (S). The nitrogen doping of the structure may be derived from any one or more selected from the group consisting of melamine, trithiocyanurate, 2-methylimidazole, polydopamine as a conductive polymer, and the like, and also, the sulfur doping of the structure may be derived from any one or more selected from the group consisting of trithiocyanurate, metal sulfides, and the like described later.

According to an exemplary embodiment, the carbon structure of the structure may be a heterointerface in contact with two or more metal sulfides. The two or more metal sulfides may include two or more sulfides selected from the group consisting of a manganese sulfide, a cobalt sulfide, zinc sulfide, and the like. Specifically, the two or more metal sulfides may include a manganese sulfide and a cobalt sulfide, and the carbon structure of the structure may be a heterointerface in contact with both the manganese sulfide and the cobalt sulfide simultaneously.

According to an exemplary embodiment, the carbon structure of the structure may have a porous structure including microporous and mesopores. The micropores refer to small pores having a diameter of 2 nm or less, and the mesopores may refer to medium sized pores having a diameter between 2 and 50 nm. Since the carbon structure of the structure includes both micropores and mesopores simultaneously, the performance of a bifunctional catalyst of electrochemical oxygen reduction (ORR) and oxygen evolution reaction (OER) may be significantly improved by an increase in active sites and facilitated migration in the carbon structure.

According to an exemplary embodiment, the structure may have a BET specific surface area of 200 m²/g or more, 250 m²/g or more, 280 m²/g or more, or 290 m²/g or more and 800 m²/g or less. The catalyst including the structure satisfying the range may provide exposure of many active sites and excellent reaction/migration paths.

According to an exemplary embodiment, the metal sulfide may be one or two or more metals selected from the group consisting of cobalt (Co), zinc (Zn), iron (Fe), cadmium (Cd), nickel (Ni), manganese (Mn), copper (Cu), and the like. Specifically, the metal sulfide may include a cobalt (Co) and a manganese (Mn) sulfides.

According to an exemplary embodiment, the metal sulfide may include sulfides of cobalt and manganese, and a mole ratio (or weight ratio) between cobalt and manganese may be 1 to 10:1, 1 to 5:1, or 2 to 3:1.

According to an exemplary embodiment, the metal sulfide may have an average particle diameter of 1 to 20 nm, 1 to 15 nm, 2 to 10 nm, or 3 to 7 nm.

According to an exemplary embodiment, the metal sulfide may have a structure in which some sulfur atoms in a crystal structure are vacant (S-vacancy). Specifically, in a process in which a sulfuration reaction occurs by a heat treatment during the manufacturing process described later, the metal sulfide may be formed by lattice deformation of some sulfur by Mn doping and thermodynamic instability. The sulfur (S)-vacancy may be confirmed by HAADF-STEM, EXAFS, XPS analysis, and the like described later. Due to the presence of S-vacancy, catalytic performance such as increased active sites, energy efficiency, and durability improvement may be significantly improved.

According to an exemplary embodiment, the metal sulfide may include a Co-S bond having a bond length of 1.7 Å or more, 1.8 Å or more, or 1.9 Å or more and 2.0 Å or less, as a result of analysis of extended X-ray absorption fine structure (EXAFS).

According to an exemplary embodiment, the catalyst may have a surface contact angle of 100° or more, 110° or more, or 115° or more and 180° or less or 150° or less.

According to an exemplary embodiment, the structure may have a thickness of 10 to 100 nm, 15 to 80 nm, or 20 to 60 nm. The thickness of the structure may be calculated by the value of outer diameter—inner diameter.

According to an exemplary embodiment, the catalyst may be a nanotube structure having an inner diameter of 10 to 300 nm, 50 to 100 nm, or 70 to 90 nm, and an outer diameter of 30 to 500 nm, 60 to 300 nm, 100 to 200 nm, or 140 to 180 nm.

According to an exemplary embodiment, the catalyst may have a nanotube structure having a length of 0.01 μm to 10 μm, 0.1 μm to 5 μm, or 0.5 μm to 3 μm.

According to an exemplary embodiment, the catalyst may be a bifunctional catalyst which may effectively promote all of two or more electrochemical reactions such as an oxygen reduction reaction (ORR) and an oxygen evolution reaction (OER).

The present invention provides a catalyst precursor for a metal-air battery including: a heteroelement-containing template including nitrogen (N) and sulfur (S); a metal-organic framework (MOF) layer; and a polymer coating layer on the metal-organic framework layer. The catalyst precursor may be converted into the catalyst described above by undergoing carbonization and sulfurization processes in a heat treatment process described later.

According to an exemplary embodiment, the template may have a nanorod structure formed by self-assembly. The template may have a nanorod structure having a diameter of 10 to 500 nm, 20 to 300 nm, 30 to 200 nm, or 50 to 100 nm and a length of 0.01 μm to 10 μm, 0.1 μm to 5 μm, or 0.5 μm to 3 μm. The template may perform a role as a template having a hollow carbon nanotube structure through a process such as a heat treatment with the metal-organic framework (MOF).

According to an exemplary embodiment, the metal-organic framework layer may include an organic ligand, a first metal, a second metal, and a third metal.

The organic ligand may include any one or more selected from the group consisting of imidazole (2-methylimidazole), melamine, trithiocyanurate, ethylene diamine, and the like.

The first metal, the second metal, and the third metal may be independently of one another one or more metals selected from the group consisting of cobalt (Co), zinc (Zn), iron (Fe), cadmium (Cd), nickel (Ni), manganese (Mn), copper (Cu), and the like.

According to an exemplary embodiment, the polymer coating layer may include a conductive polymer. The conductive polymer may include any one or more selected from polydopamine, polyaniline, polypyrrole, polyacetylene, poly(p-phenylene), poly(p-phenylenevinylene) (PPV), polythiophene, poly(3,4-ethylenedioxythiophene) (PEDOT), polyindole, polyphenol, and the like. Specifically, the polymer coating layer may include polydopamine. The polymer coating layer may have a thickness of 1 to 100 nm, 1 to 50 nm, or 3 to 15 nm. The polymer coating layer is coated on a metal-organic framework formed on a nanorod template surface to keep the catalytic shape from collapsing in a sulfurization/carbonization process and suppress aggregation of metal sulfide particles.

The present invention may provide an air-cathode including a coating layer including the catalyst for a metal-air battery described above. The structure of the air-cathode may use a structure or a raw material which is known or commonly used in the industrial field, except for using the catalyst for a metal-air battery.

According to an exemplary embodiment, the coating layer may include 30 to 99 wt %, 50 to 99 wt %, or 60 to 95 wt % of the catalyst for a metal-air battery.

According to an exemplary embodiment, the coating layer may further include binder. The binder may be used for improving adhesive strength of the catalyst and may use materials used in the art without limitation. Nafion, PTFE, or the like may be used without limitation, but the present invention is not limited thereto.

According to an exemplary embodiment, the coating layer may further include a conducting agent. As the conducting agent, carbon black, graphite, carbon nanotubes (CNT), graphene, silver, nickel, tin oxide, iron oxide, and the like may be used, but materials used in the art may be used without limitation.

According to an exemplary embodiment, the coating layer may be applied at a thickness of 0.1 to 50 μm or 1 to 30 μm. In addition, the air-cathode may have a catalyst loading amount per area of 0.01 to 50 mg/cm², 0.1 to 30 mg/cm², or 0.5 to 10 mg/cm².

The present invention may provide a metal-air battery including: an anode; an electrolyte; and the air-cathode described above. The structure of the metal-air battery may use a structure or a raw material which is known or commonly used in the industrial field, except for using the air-cathode including the catalyst for a metal-air battery.

According to an exemplary embodiment, the anode may be a metal anode, and the metal anode may be a zinc metal.

According to an exemplary embodiment, the electrolyte may be a basic aqueous solution electrolyte, and the electrolyte may include a hydroxide solution. The hydroxide solution may be any one or more selected from the group consisting of NaOH, KOH, Mg(OH)₂, Ca(OH)₂, and Ba(OH)₂.

The present invention provides a method for manufacturing a catalyst for a metal-air battery including:
(A) forming a heteroelement-containing template including nitrogen (N) and sulfur (S);
(B) forming a metal-organic framework layer on the template;
(C) forming a polymer coating layer on the metal-organic framework layer; and
(D) performing a heat treatment.

According to an exemplary embodiment, the catalyst precursor described above may be manufactured through (A), (B), and (C), and then (D) may be performed.

According to an exemplary embodiment, (A) may be self-assembling melamine and trithiocyanuric acid to manufacture a template. The melamine and trithiocyanuric acid may satisfy a mole ratio of 1 to 9:1, 1 to 5:1, or 1 to 2:1.

According to an exemplary embodiment, (B) may include: forming a metal-organic framework including a first metal and a second metal; and introducing a third metal to the metal-organic framework. The first metal and the second metal may be independently of each other cobalt, zinc, or manganese, and the third metal may be cobalt or manganese. The metal and the organic ligand described above may be reacted to form a metal-organic framework. In addition, a mole ratio of the first metal: the second metal: the third metal may be 1 to 5:1 to 5:1 to 5 or 1 to 2:1 to 2:1 to 2.

According to an exemplary embodiment, (D) may include carbonization and sulfurization processes. (D) may be performed at a temperature of 700° C. or higher, 800° C. or higher, or 880° C. or higher and 1500° C. or lower for 10 minutes or more, 30 minutes or more, or 100 minutes or more and 1000 minutes or less.

According to an exemplary embodiment, a part of the template may be vaporized to form a hollow structure, by performing (D). Specifically, by performing (D), molecules such as an organic ligand, polydopamine (PDA), and melamine of the template may be thermally decomposed and carbonized, metal (in particular Zn) may be volatilized at a high temperature, and thus, the inside of the nanorod structure is vaporized to form a nanotube form having a hollow inside. In addition, by performing (D), heteroelements such as nitrogen and sulfur may be doped into the carbon structure in the decomposition process.

According to an exemplary embodiment, by performing (D), a heteroelement, specifically nitrogen and sulfur elements may be doped into the polymer coating layer. A concentration of nitrogen doping may be 1 to 20 atom %, 2 to 15 atom %, or 5 to 10 atom % with respect to the entire catalyst, and a concentration of sulfur doping may be 1 to 10 atom %, 2 to 6 atom %, or 3 to 4 atom % with respect to the entire catalyst, analyzed by XPS analysis. The metal of the metal-organic framework layer may be sulfurized to form a metal sulfide.

A catalyst including a nitrogen/sulfur doping carbon structure having a hollow structure formed may be manufactured by Zn volatilization according to the manufacturing method described above. The catalyst is bifunctional, and a zinc-air battery having excellent durability and high output may be manufactured using the catalyst.

Hereinafter, the examples of the present invention will be described in detail with reference to the attached drawings. However, they are provided so that the present invention may be easily carried out by those skilled in the art, the present invention may be implemented in various forms, and the idea of the present invention is not necessarily limited to the examples.

### Example 1

70 mL of deionized water in which melamine (1.94 g) was dissolved and 30 mL of deionized water in which trithiocyanuric acid (2.73 g) was dissolved were mixed and stirred for 20 minutes to perform a reaction. After the reaction, the product was washed with deionized water and ethanol 3 times, respectively, and then dried at 60° C. for 12 hours to obtain an MTCA nanorod template.

300 mg of the formed MTCA template was dispersed in 40 mL of a methanol-ethanol (1:1) mixed solvent, and 2-methylimidazole (16 mmol) was added. Cobalt (II) nitrate (Co(NO₃)₂, 1 mmol) including the first metal and zinc nitrate (Zn(NO₃)₂, 0.5 mmol) including the second metal were completely dissolved in 40 mL of a solvent in a separate container, then mixed with a MTCA dispersion, and stirred for 2 minutes, and then reacted at room temperature for 12 hours. The produced Co/Zn-MOF@MTCA precipitate was centrifuged and dried at 60° C. for 12 hours.

The dried Co/Zn-MOF@MTCA powder was dispersed in 40 mL of ethanol, and a manganese salt (Mn salt, dissolved in 5 mL of deionized water) including the third metal was slowly added dropwise. The mixture was reacted by stirring for 24 hours, the product was washed with deionized water and ethanol 3 times, respectively, and then dried in an oven overnight to manufacture Mn—Co/Zn-MOF@MTCA.

300 mg of the manufactured Mn—Co/Zn-MOF@MTCA was added to 30 mL of a Tris buffer, and sonicated for 10 minutes. Dopamine hydrochloride (35 mg) was added thereto and stirred for 2 hours to form a polydopamine coating layer on the surface. After the reaction, the product was centrifuged and washed, and dried in an oven for 12 hours.

The Mn—Co/Zn-MOF@MTCA powder coated with PDA was heat-treated at 900° C. for 2 hours in an argon (Ar) atmosphere to synthesize a CM@SNHCT catalyst. Thereafter, the produced powder was washed in a 0.1 M HCl solution (80° C.) to remove unnecessary metal or unstable components, finally washed with deionized water, and dried to finally obtain the catalyst for a metal-air battery according to Example 1.

The catalyst for a metal-air battery according to Example 1 was analyzed according to the following method.

### Comparative Example 1

The catalyst (C@SNHCT) according to Comparative Example 1 was obtained in the same manner as in Example 1, except that a manganese salt was not added.

### Comparative Example 2

The catalyst (M@SNHCT) according to Comparative Example 2 was obtained in the same manner as in Example 1, except that a manganese salt was added instead of adding cobalt (II) nitrate.

### Comparative Example 3

The catalyst (CM) according to Comparative Example 3 was obtained in the same manner as in Example 1, except that the polydopamine coating layer was not formed.

### Evaluation Example 1

### Morphological and Structural Analysis

The MTCA nanorod template of Example 1 and the catalyst for a metal-air battery according to Example 1 were analyzed by a scanning electron microscope (FE-SEM, JSM-IT800), a transmission electron microscope (Talos F200X G2 TEM), and high-resolution transmission electron microscope (HR-TEM).

FIG. 2 shows SEM, TEM, and HR-TEM images. It was confirmed from the SEM image of (a) and the TEM image of (b) that the catalyst of Example 1 had a hollow nanotube structure having a size of an outer diameter of about 165 nm and an inner diameter of about 80 nm. In addition, it was confirmed from (c) of FIG. 2 that Co₉S₈/MnS heterojunction nanoparticles having an average particle diameter of 5.27 nm were uniformly distributed inside the nanotubes, and a lattice spacing was 0.175 nm and 0.185 nm, respectively, in the (440) plane of Co₉S₈ and the (200) plane of MnS, and a structure in which a sulfur atom was vacant (S-vacancy) by the Jahn-Teller effect by introducing MnS to a catalyst crystal structure was confirmed from (d) of FIG. 2.

In addition, size distribution statistical analysis of metal sulfide nanoparticles present in the catalyst was performed by counting 200 particles or more in an HR-TEM image with an ImageJ software, and 5.27 nm of an average diameter and about 0.65 nm of a standard deviation were shown. Since the metal sulfide according to Example 1 had a very uniform particle distribution, and particles of 5-6 nm accounted for 72% or more of the total, it was confirmed that it was advantageous for exposure of efficient active sites.

### Evaluation Example 2

### Composition and Chemical State Analysis

The crystal phase and composition change of catalyst powder were evaluated using an X-ray diffraction analyzer (XRD, SmartLab, Rigaku). Measurement was performed under a Cu—Kα radiation (λ=1.54 Å) condition, in a range of 2θ=10~80°, and a scan speed of 2°/min. As a result, peaks at (002) and (101) planes of graphitized carbon were clearly observed around 25° and 44° in the CM@SNHCT sample. In addition, since the characteristic crystal planes of Co₉S₈ were detected in 15.5°, 29.8°, 31.3°, 39.6°, 47.6°, 52.1°, and the like and the peaks corresponding to the crystal planes of MnS were detected in 34.5° and 39.6°, it was confirmed that two sulfide phases coexisted. Since the peak of a metal (Co, Mn) single phase was not detected, it was confirmed that all metals were completely converted into a sulfide phase.

In addition, the vacancy and graphitization degree of a synthesized carbon structure were analyzed using a Raman spectrometer (ARAMIS, Horiba). As a result of measurement using a 532 nm laser, the characteristic peaks of graphitic carbon and defective carbon were shown at about 1590 cm⁻¹ (G band) and 1350 cm⁻¹ (D band), an ID/IG ratio of CM@SNHCT was confirmed to be 1.01, and thus, it was found that the degree of defects was high as compared with Comparative Example 1 (C@SNHCT, ID/IG 0.95). This was predicted to be a structural vacancy introduced by S/N doping and metal-carbon interaction.

In addition, the element composition and the chemical state of the catalyst surface were analyzed by an X-ray photoelectron spectrometer (XPS, Axis-Supra, Kratos). As a result of analysis, the characteristic peaks of Co 2p, Mn 2p, S 2p, N 1s, C 1s, and the like were evenly detected on the surface of CM@SNHCT, and it was shown that two oxidation states of Co²⁺ (780.6 eV) and Co³⁺ (778.3 eV) were mixed in the Co 2p spectrum. In particular, as Mn was introduced, a downward migration phenomenon in which Co 2p binding energy was lowered to 0.38 eV was observed, and it was found that electron transfer from Mn to Co occurred. In addition, since various bonding states such as Co—S (161.6 eV), Mn—S (162.8 eV), C—S—C (163.8 eV), and C═S (164.8 eV) were detected in the S 2p spectrum, it was confirmed that sulfur doping of a carbon body and heterometal sulfide structure were well formed.

Furthermore, the oxidation states and the bonding environment of Co and Mn were evaluated using X-ray absorption spectroscopy (XAS, KIST XAFS system). In the Co K-edge XANES result, the oxidation state of Co was close to +2, the Co-S bonding length in the Fourier-transform (FT) EXAFS spectrum was increased to 1.93 Å in CM@SNHCT as compared with C@SNHCT (1.78 Å), lattice distortion and electronic structure changes by introducing Mn occur, and this was confirmed to be the reason for S atom vacancy. Mn K-edge was similarly confirmed to be an Mn²⁺ oxidation state, and an increased electrochemical activity of Co was expected due to an electron redistribution effect.

In addition, the element composition and distribution in the catalyst were confirmed from energy dispersive X-ray spectroscopy (TEM-EDS)-attached TEM (Talos F200X G2). As a result, it was visually verified that all elements such as Co, Mn, S, N, and C were uniformly distributed throughout the nanotube which was a structure, and as a result of TEM-EDS quantitative analysis, it was confirmed that the atomic ratio of the catalyst was composed of Co (18.31 at %), Mn (1.10 at %), S (12.79 at %), N (5.17 at %), and C (62.63 at %), and it was visually confirmed that the interface structure of a heterometal sulfide was well formed in that Co and Mn coexisted in the same area.

Therefore, it was confirmed that the CM@SNHCT catalyst according to Example 1 had a structure in which ultrafine Co₉S₈/MnS heterojunction nanoparticles were evenly distributed inside the S, N doped-hollow nanotube, and a high performance catalyst having maximized lattice vacancy and active site exposure was manufactured.

### Evaluation Example 3

### Analysis of Physical Properties and Surface State

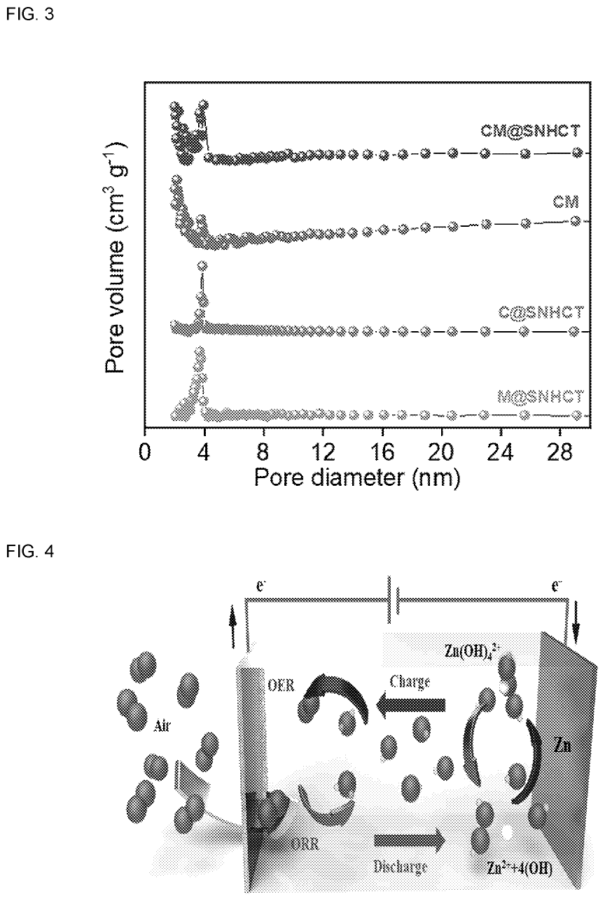

In order to evaluate the specific surface area and the pore structure of the catalyst, nitrogen adsorption-desorption (BET) analysis using Micromeritics 3Flex was performed. As a result of analyzing a freeze-dried powder sample at a liquid nitrogen temperature of 77 K, the BET surface area of CM@SNHCT of Example 1 was 300.12 m²/g, which was significantly increased as compared with 176.45 m²/g of Comparative Example 1 (C@SNHCT). In addition, as seen in the pore size distribution graph shown in FIG. 3, it was confirmed from Barrett-Joyner-Halenda (BJH) analysis that the nitrogen adsorption-desorption curve of the catalyst of Example 1 showed a typical type IV isotherm and a distinct hysteresis loop, and mesopores of 4 to 24 nm and micropores of less than 2 nm coexisted in the carbon body of Example 1, and thus, it was confirmed that a porous structure by Zn and melamine evaporation was well formed. The double pores structure in which mesopores which may effectively access to active sites and micropores having excellent reactivity coexisted as in Example 1 may implement smooth diffusion of oxygen/ion·electrolyte and accelerated reaction rate.

In addition, hydrophobicity on the catalyst surface was evaluated by measuring a contact angle (contact angle analyzer). A flat plate carbon paper was coated with the catalyst powders according to the example and the comparative examples, a drop of water (about 5 μL) was dropped onto each specimen to measure the contact angle immediately, and as a result, the contact angle of CM@SNHCT of Example 1 was 121.31° which showed very high hydrophobicity. However, C@SNHCT without Mn was 90.98° which was a relatively low value. The high contact angle of Example 1 was predicted to be due to the fact that the carbon body of the structure had increased hydrophobicity by the surface C—S—C bond produced by S doping, and thus, excessive penetration of an electrolyte was suppressed during manufacture of a battery later, and gas (oxygen) diffusion in the electron-electrolyte interface was facilitated.

### Evaluation Example 4

### Oxygen Electrocatalyst Performance Evaluation

For electrochemical performance evaluation of the catalysts manufactured according to the example and the comparative examples, a 3-electrode cell was manufactured, and cyclic voltammetry (CV) and linear sweep voltammetry (LSV) analysis were performed.

First, 5 mg of the catalyst powders manufactured according to the example and the comparative examples were dispersed in 1 mL of ethanol and Nafion (5 wt %, 50 μL) to prepare a catalyst ink, which was drop cast on a glass carbon rotating disk electrode (RDE, 3 mm), coated at 0.25 mg/cm² (ORR evaluation) or 1 mg/cm² (OER), and dried. Subsequently, a 3-electrode cell including the RDE coated with the catalyst layer as a working electrode, Hg/HgO as a reference electrode, a Pt line as a control electrode, and O₂ saturated 0.1 M KOH as an electrolyte was formed, and the performance evaluation of electrochemical oxygen reduction (ORR) and oxygen evolution reaction (OER) was performed using BioLogic VSP potentiostat-galvanos equipment.

The oxygen reduction reaction (ORR) performance was LSV analyzed using a rotating ring-disk electrode (RDE) in a 0.1 M KOH solution, with Koutecky-Levich analysis by measurement at a scan speed of 5 mV/s and various rotation speeds, and as a result, an onset potential (E₀) of 0.93 V and a half-wave potential (E_{1/2}) of 0.84 V were shown. In addition, a diffusion limited current was larger than Pt/C, and it was confirmed that current reactivity to oxygen reduction was excellent. In addition, the number (n) of electron transfer derived from Koutecky-Levich analysis was close to 4, and it was confirmed therefrom that the catalyst according to Example 1 performed ORR through a 4-electron reaction path. As a result of a chronoamperometry test, when the catalyst of Example 1 was used, 96.5% of the initial current density was maintained even after 25 hours, and Pt/C was rapidly decreased to 87.8% within 15 hours.

Oxygen evolution reaction (OER) performance was LSV analyzed with 95% iR calibration in a 1M KOH electrolyte, and as a result, overvoltage (overpotential) of 275 mV was required for achieving a current density of 10 mA/cm², and overvoltage of 332 mV was shown at 100 mA/cm². In addition, a Tafel slope showing the reaction rate of OER was measured as 64.4 mV/dec, which was the lowest value among the control group including the commercial IrO₂ catalyst. Thus, it was confirmed that the catalyst of the present invention showed an excellent reaction rate and a low energy barrier for OER.

In addition, an electrochemically active surface area (ECSA) was indirectly calculated by measuring a double layer electrical capacity (Cdl) through CV. As a result of measurement, the catalyst of Example 1 showed a significantly high level of Cdl value of 40.62 mF/cm², and it was confirmed therefrom that since the catalyst of the present invention exposed more reactive active sites to the surface, excellent activity may be expressed in the electrochemical reaction.

In addition, in the cycling test, there was no activity loss, and overpotential was slightly increased to 7 mV even after 5000 cycles at 10 mA/cm². Furthermore, in order to evaluate reversibility of the oxygen reaction, a potential difference (ΔE) between the half-wave potential (E_{1/2}) of the oxygen reduction reaction and the overvoltage at 10 mA/cm² in the oxygen evolution reaction was calculated. As a result, when the catalyst of Example 1 was used, ΔE=0.68 V was shown, and thus, it was shown that the catalyst of the present invention showed balanced bifunctional performance in both ORR and OER, and realized excellent bidirectional reaction reversibility.

### Evaluation Example 5

### Battery Performance Evaluation

A battery was manufactured using the catalyst of Example 1 as an air-cathode of a water-based zinc-air battery, and a zinc foil as an anode, and is shown in FIG. 4.

Specifically, 5 mg of the catalyst powder manufactured according to Example 1 was dispersed in 1 mL of ethanol and Nafion (5 wt %, 50 μL) to prepare a catalyst ink, which was coated on the surface of carbon paper (1 cm²) by drop casting at 1 mg/cm², and dried to manufacture an air-cathode. The anode was prepared by cutting a high-purity zinc (Zn) foil into an appropriate size, and a 6 M KOH+0.2 M Zn acetate aqueous solution was used as the electrolyte. The air-cathode and the zinc anode were placed in parallel to each other, the electrolyte was sufficiently injected therebetween, assembly was performed, and each component was fixed using a cell holder to complete a single battery. Various electrochemical characteristics of the battery such as open circuit voltage (OCV), discharge/charge curve, maximum power density, energy density, and cycle life were evaluated.

The open circuit voltage (OCV) of the zinc-air battery (ZAB) using the catalyst manufactured in Example 1 was measured, and since it showed stable OCV at 1.45 V for 10 hours, it was confirmed to be at a very similar level to 1.46 V which is the OCV of commercial Pt/C+IrO₂-based ZAB.

In addition, a discharge/charge curve was obtained in a galvanostatic (constant current) mode, respectively, in a current density range of 5 to 100 mA/cm² of the zinc-air battery using the catalyst of Example 1, with charging at 10 mA/cm². As a result of evaluating discharge rate characteristics by changing the current density from 5 to 100 mA/cm², excellent stability was shown in all current density conditions, and even when the current density was restored from 100 mA/cm² to 5 mA/cm², performance was completely recovered, and excellent reversibility was confirmed. In addition, as a result of determining a maximum output density by calculating a product of voltage (V) and current (I) (P=V×I, mW/cm²) measured in each current value in real time while increasing current density, the battery of the example showed a maximum output density of 185 mW/cm², which exceeds 170 mW/cm² of Pt/C+IrO₂.

In addition, as a result of measuring a specific capacity based on Zn consumption, the specific capacity of ZAB based on the catalyst of Example 1 was 808 mAh/g, showing higher performance than a Pt/C+IrO₂-based system showing about 737 mAh/g under the same conditions (10 mA/cm²). Long-term stability was also evaluated by a continuous constant current charge/discharge test, and only an extremely small voltage difference (voltage gap) was shown at 10 mA/cm² for 250 hours, but Pt/C+IrO₂-based ZAB showed a large performance reduction within only 25 hours, the energy efficiency of ZAB based on the catalyst of Example 1 was only slightly decreased from 67% to 59%, and thus, it was confirmed that durability and reversibility were excellent.

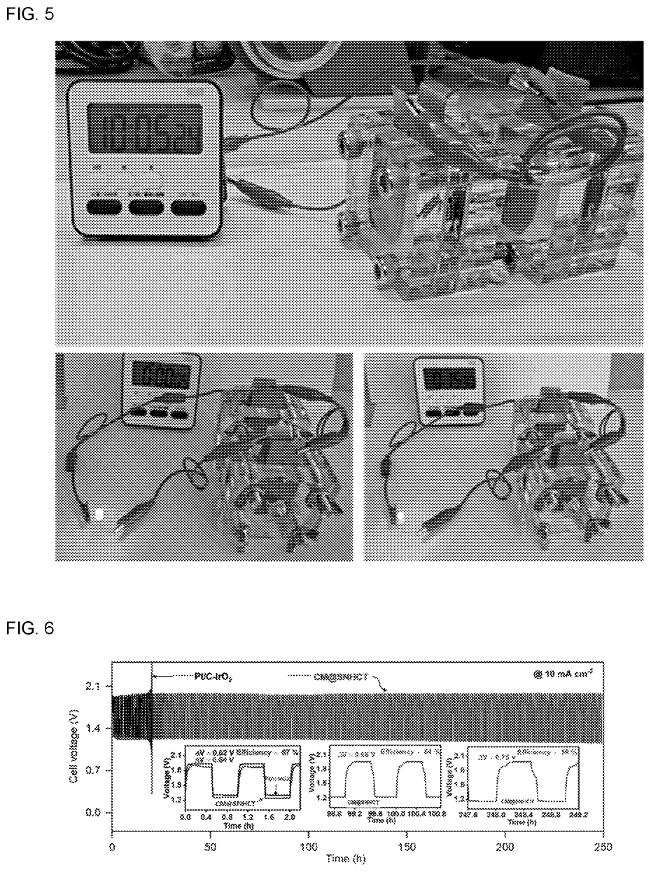

In addition, during constant current discharge of the calculated specific energy density (10 mA/cm²) of the battery of Example 1, the total discharge capacity of ZAB (based on consumption of a zinc anode, unit: mAh) and the average discharge voltage were combined, and the value was divided by a zinc weight (kg) (calculated as Wh/kg) to obtain 993.84 Wh/kg, which was the highest level of ZAB performance to date, and the results confirmed that the battery of the present invention outperformed the commercial precious metal-based Pt/C+IrO₂ system and had excellent performance as compared with latest high-performance ZAB technology. In FIG. 5, an experiment in which the battery using the catalyst according to Example 1 was connected in series to operate a digital timer and a green LED bulb was turned on was recorded.

In addition, the cycle life of the battery of Example 1 was evaluated by automatically and repeatedly operating ZAB for 250 hours (750 cycles) or more under the conditions of charging for 10 minutes—discharging for 10 minutes at 10 mA/cm², using a potentiostat program, and continuously monitoring charge/discharge voltage maintenance and performance reduction (such as voltage drop and capacity decrease) of each cycle, and the results are shown in FIG. 6.

The excellent durability and high efficiency of the battery using the catalyst according to an exemplary embodiment is a synergistic effect from continuous charge transfer characteristics promoted by the precise Co/Mn sulfide heterostructure having rich vacancy defects and a graphitized carbon substrate doped with a heteroelement, and is a unique effect implemented by the organic combination of the components of the present invention.

The catalyst for a metal-air battery according to an embodiment of the present invention shows high electrochemical activity for both an oxygen evolution reaction (OER) and an oxygen reduction reaction (ORR), thereby improving battery energy efficiency and output characteristics. In particular, since adsorption and desorption energies of *OH, *O, and *OOH intermediates, which are the main active species of the electrochemical reaction, are precisely adjusted, overvoltage of the reaction is lowered, and a reaction rate is increased. Accordingly, the catalyst of the present invention may achieve both low overvoltage and high reduction potential simultaneously and implement excellent reversibility in a bidirectional oxygen reaction.

In addition, the catalyst of the present invention may greatly improve long-term lifespan and output maintenance characteristics of the metal-air battery, by maintaining stable catalytic activity without structural collapse or an activity decrease even in a long-term repeated charge/discharge environment. These are unique effects of the present invention which are implemented by adjusting electron density and binding energy of a catalyst surface through doping and vacancy defect control to improve chemical stability and electron transfer characteristics of active sites, and thus, the catalyst of the present invention may implement battery performance such as high energy density, high output density, and long-term lifespan, and may be used as a practical and economically excellent alternative which may replace a precious metal catalyst.

In addition, in the method for manufacturing a catalyst for a metal-air battery of the present invention, precursor synthesis is mostly performed at room temperature, and a hollow structure and a porous structure may be simultaneously formed by selective evaporation of Zn and an organic material in a final heat treatment step. This shortens electron and material transfer pathways to decrease internal resistance during battery operation and allow high-speed reaction characteristics. As such, the manufacturing method of the present invention is simple, has high reproducibility, and may be applied even to a mass production process.

Hereinabove, although the present invention has been described by specific exemplary embodiments, they have been provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to the above-described exemplary embodiments, and the following claims as well as all modifications equal or equivalent to the claims are intended to fall within the scope and spirit of the invention.

1. A catalyst for a metal-air battery comprising: a hollow inside; and a porous structure containing a metal sulfide.

2. The catalyst for a metal-air battery of claim 1, wherein the structure includes a carbon structure doped with two or more heteroatoms.

3. The catalyst for a metal-air battery of claim 1, wherein the structure includes a carbon structure doped with nitrogen (N) and sulfur(S).

4. The catalyst for a metal-air battery of claim 3, wherein the carbon structure of the structure is a heterointerface in contact with two or more metal sulfides.

5. The catalyst for a metal-air battery of claim 3, wherein the carbon structure of the structure includes micropores and mesopores.

6. The catalyst for a metal-air battery of claim 1, wherein the metal sulfide includes one or two or more metals selected from the group consisting of cobalt (Co), zinc (Zn), iron (Fe), cadmium (Cd), nickel (Ni), manganese (Mn), and copper (Cu).

7. The catalyst for a metal-air battery of claim 1, wherein the metal sulfide includes a cobalt (Co) sulfide and a manganese (Mn) sulfide.

8. The catalyst for a metal-air battery of claim 1, wherein the metal sulfide includes a structure in which some sulfur atoms in a crystal structure are vacant (S-vacancy).

9. The catalyst for a metal-air battery of claim 1, wherein the catalyst is a bifunctional catalyst.

10. A catalyst precursor for a metal-air battery comprising:
a heteroelement-containing template including nitrogen (N) and sulfur (S);
a metal-organic framework layer on the template; and
a polymer coating layer on the metal-organic framework layer.

11. The catalyst precursor for a metal-air battery of claim 10, wherein the template has a nanorod structure.

12. The catalyst precursor for a metal-air battery of claim 10, wherein the metal-organic framework layer includes an organic ligand, a first metal, a second metal, and a third metal.

13. The catalyst precursor for a metal-air battery of claim 10, wherein the polymer coating layer includes polydopamine.

14. An air-cathode comprising a coating layer including the catalyst for a metal-air battery of claim 1.

15. A metal-air battery comprising an anode; an electrolyte; and the air-cathode of claim 14.

16. A method for manufacturing a catalyst for a metal-air battery, the method comprising:
(A) forming a heteroelement-containing template including nitrogen (N) and sulfur (S);
(B) forming a metal-organic framework layer on the template;
(C) forming a polymer coating layer on the metal-organic framework layer; and
(D) performing a heat treatment.

17. The method for manufacturing a catalyst for a metal-air battery of claim 16, wherein (A) is self-assembling melamine and trithiocyanuric acid to manufacture a template.

18. The method for manufacturing a catalyst for a metal-air battery of claim 16, wherein (B) includes:
forming a metal-organic framework including a first metal and a second metal; and
introducing a third metal to the metal-organic framework.

19. The method for manufacturing a catalyst for a metal-air battery of claim 16, wherein a part of the template is vaporized to form a hollow structure, by performing (D).

20. The method for manufacturing a catalyst for a metal-air battery of claim 16, wherein the heteroelement is doped into the polymer coating layer, and a metal of the metal-organic framework layer is sulfurized to form a metal sulfide, by performing (D).
